(19) United States
(12) Patent Application Publication
(10) Pub. No.: US 2025/0062090 A1
(43) Pub. Date: Feb. 20, 2025

(54) Fast-Acting Mechanical Switch and Its Operating Method

(71) Applicant: Eaton Electrical Ltd., Suzhou (CN)

(72) Inventors: Shunfeng Guo, Suzhou (CN); Hui Zhou, Suzhou (CN); Wenzhe Fan, Suzhou (CN); Jianhua Chen, Suzhou (CN); Zhengning Hu, Suzhou (CN)

(21) Appl. No.: 18/802,045

(22) Filed: Aug. 13, 2024

(30) Foreign Application Priority Data
Aug. 14, 2023 (CN) 2023110175961
Aug. 14, 2023 (CN) 2023221756600

(51) Int. Cl. H01H 33/664; H01H 33/666

(52) U.S. Cl. CPC H01H 33/664; H01H 33/666

(57) ABSTRACT

The present disclosure relates to a fast mechanical switch and an operating method, wherein the fast mechanical switch comprises: a closed housing; a vacuum interrupter; an electromagnetic repulsion mechanism disposed below the vacuum interrupter, wherein the electromagnetic repulsion mechanism has: a first repulsion unit electrically connected to a first electrical terminal; a second repulsion unit electrically connected to a second electrical terminal independent of the first electrical terminal and comprising a third repulsion disk located below and spaced apart from the second repulsion disk, wherein the second electrical terminal is constructed to operatively control the third repulsion disk responsive to the first repulsion unit such that the third repulsion disk applies a resistance to the second repulsion disk when the second repulsion disk is moved downwardly for opening and applies an thrust to the second repulsion disk when it is moved upwardly for closing. The present disclosure permits the operation of fast mechanical switches in a manner that is more efficient, has a longer product life cycle, is more accurately controlled, and is less difficult to control.

### CROSS-REFERENCE TO RELATED APPLICATIONS

This application claims the benefit of Chinese patent application nos. 2023110175961 and 2023221756600, both filed on Aug. 14, 2023, the contents of each of which is hereby incorporated herein by reference in their entireties.

### TECHNICAL FIELD

The present disclosure relates to the technical field of high-voltage switchgear for power distribution networks, and specifically to a fast mechanical switch and its operating method.

### BACKGROUND

With the increasingly progressive power electronic technology, DC transmission technology in Europe, North America, China, and other countries and regions to get more and more popularization and application, a large number of DC projects put into operation, DC transmission control, protection, fault, reliability and so on more and more important.

Driven by the increasingly advanced power electronics technology, DC transmission technology has been increasingly promoted and applied in countries and regions such as Europe, North America, and China. With the commissioning of a large number of DC projects, the control, protection, fault, and reliability of DC transmission have become increasingly important.

When a DC transmission system fault occurs, a large short-circuit current will be generated, and the fault current rises very quickly, so it is necessary to open the DC circuit breaker as soon as possible. However, most of the existing mechanical switch actuators for circuit breakers are spring actuators and hydraulic actuators, which have a long opening time, and are unable to realize opening and breaking the circuit breaker in a short time, and cannot meet the time requirements for switch opening and closing.

The utility model patent application with the public number CN204332796U discloses a kind of ultra-high speed mechanical switch, the mechanical switch's motion disk drives the switch lever to do the opening and closing movement to compress the gas in the sealing cavity in the direction of the movement of the side of the sealing cavity, due to the sealing cavity's opening and closing position or near the opening and closing position of the sealing cavity of the peripheral wall set up with the sealing cavity inside and outside of the through holes, resulting in compression of gas from the through holes, this will greatly reduce the compression of the gas on the movement direction of the switch. This will greatly reduce the compressed gas on the reaction force of the movement disk, so that the switch lever high-speed switch, and when the movement disk is about to move to the position of the switch, the movement disk of the periphery will gradually block the sealing cavity peripheral wall of the through-hole, from the through-hole in the amount of compressed gas discharged from the through-hole will gradually reduce the pressure of the gas increased unprecedentedly, on the movement of the disk of the reaction force increased dramatically, and play an effective buffering of the movement disk.

In practice, it is found that the above ultra-high-speed mechanical switch in the operating mechanism due to the action of the link more, cumulative movement tolerance Ambassador of its response time dispersion is large, long switching time, and easy to be affected by their respective characteristics and failures. For this reason, with the development of electronic control technology, electronic operating mechanisms came into being, especially after the emergence of the new permanent magnet operating mechanism, so the theory of electronic operation in the electrical switch has been widely practiced and applied. A permanent magnet operating mechanism has many advantages, such as simple transmission components, faster movement speed, better controllability, and other advantages, to a certain extent, to adapt to the new requirements of modern power system development. At the same time, the research of another electronic operating mechanism—the electromagnetic repulsion mechanism is also quietly emerging at home and abroad. Due to its advantages of simple structure, short mechanical delay time, fast initial movement speed, and good controllability, it has attracted great attention in the study of fast switching.

It is known to propose that a metal repulsion disc of aluminum alloy can be used, and a moving contact is connected to the metal repulsion disc by a connecting rod, such as a vacuum interrupter disclosed in the Chinese invention patent application with application publication number CN107481889A, in which the conductive rod is fixedly connected to the electromagnetic repulsion disc, and the two sides of the electromagnetic repulsion disc are arranged with an opening driving coil and a closing driving coil, which are built-in respectively. The closing drive coil is built into the splitting drive coil and the closing drive coil respectively, and through the work of the two coils, a repulsive force is generated between the coil and the electromagnetic repulsive disk, which causes the electromagnetic repulsive disk to reciprocate along the movable conductive rod between the two coils, thereby driving the moving contacts to carry out the splitting and closing motions. However, the electromagnetic repulsion disk is fast due to its movement speed, and accordingly, at the end of the movement, it will impact the structure where the coil is located, so that the electromagnetic repulsion disk and the structure where the coil is located will be subjected to a large impact, which will cause the electromagnetic repulsion disk and the coil to be susceptible to cracking and damage, which will lead to a reduction in the reliability of the product. Further, since the metal repulsion disk made of aluminum alloy generates an eddy current with the help of a driving coil, which drives the metal repulsion disk, a large amount of electrical energy in this type of fast actuator is converted into useless heat and dissipated, resulting in low driving efficiency, limited closing and closing speeds, and limited service life, among many other shortcomings. Further, this type of battery repulsion mechanism also has many shortcomings such as low control accuracy and high control difficulty.

Therefore there exists a technical need in this field to propose new solutions allowing for snap-action mechanical switches that are more efficient, have a longer product life cycle, have higher control accuracy and are less difficult to control.

### SUMMARY OF THE INVENTION

Therefore, the task of the present disclosure is to provide a fast-acting mechanical switch and its operating method, thereby overcoming the above-mentioned disadvantages of the prior art.

According to one aspect of the present disclosure, a fast-acting mechanical switch is provided, which comprises: —a closed housing; —a vacuum interrupter, wherein the vacuum interrupter is provided with a stationary fixed contact and a moving contact being capable of slidingly engage therewith, wherein the fixed contact is connected to a first busbar projecting out of the housing and the moving contact is connected to a second busbar projecting out of the housing; —an electromagnetic repulsion mechanism located below the vacuum interrupter, which is fixedly connected to the vacuum interrupter via a transmission rod, wherein the electromagnetic repulsion mechanism comprises: —a first repulsion unit electrically connected to the first electrical terminal, comprising a first repulsion disk which is fixed and a second repulsion disk which is located below thereof and separated therefrom, wherein the second repulsion disk is fixedly connected to the transmission rod via a drive rod passing through the first repulsion disk to drive the vacuum interrupter to open or close; —a second repulsion unit electrically connected to a second electrical terminal independent of the first electrical terminal, comprising a third repulsion disk located below and spaced apart from the second repulsion disk, wherein the second electrical terminal is configured to operatively control the current supplied to the third repulsion disk in response to the first repulsion unit such that the third repulsion disk applies a resistance to the second repulsion disk when the second repulsion disk is moved downwardly for opening and applies a thrust to the second repulsion disk when it is moved upwardly for closing.

As a result, unlike the prior art, the present disclosure has higher driving efficiency, higher control accuracy, and lower control complexity relative to the coil metal disk structure by adopting a repulsion disk with a coil-repulsion disk as the driving structure of the repulsion mechanism; and reduces the size and the movement inertia of the driving components of the fast-acting repulsion unit to protect the components of the repulsion mechanism and extend the life of the repulsion mechanism. A bidirectional repulsion structure is formed by using a repulsion disk independently energized by the first electrical terminal and the second electrical terminal, respectively, which helps to improve the rapidity of switch closing and opening.

As a preferred aspect, each of said first repulsion disk, second repulsion disk and third repulsion disk comprises a disk-shaped frame base and a first repulsion coil and a second repulsion coil fixed to both axial sides of the frame base, wherein the first repulsion coil is provided with an input terminal and the second repulsion coil is provided with an output terminal.

As a preferred aspect, both the output terminal of the first repulsion disk and the input terminal of the second repulsion disk are connected in series to the first electrical terminal to form a series circuit between them so that the current flow in the repulsion coils of the first repulsion disk and the current flow in the repulsion coils of the second repulsion disk are reversed and a repulsive force is generated between the first repulsion disk and the second repulsion disk.

As a preferred aspect, the output terminal of the first repulsion disk and the input terminal of the second repulsion disk are connected in parallel to the first electrical terminal to form a parallel circuit between the two in opposite directions of current, thereby generating a repulsive force between the first repulsion disk and the second repulsion disk.

As a preferred aspect, wherein both the first electrical terminal and the second electrical terminal are configured to serially connect to an energy storage capacitor, a current limiting resistor, and an operating switch capable of controlling the current conduction of the repulsion disk.

As a preferred aspect, the inner wall of the vacuum interrupter is provided with a bellows disposed on the outer side of the drive rod, wherein one end of said bellows is hermetically connected to an end portion of the vacuum interrupter in order to always keep a hermetic seal of the vacuum interrupter.

As a preferred aspect, there is further included a holding mechanism pivotally connected to said drive rod between the vacuum interrupter and the electromagnetic repulsion mechanism, the holding mechanism comprising: —a slider capable of sliding between a holding position and a retracted position; —a connecting rod pivotally connected to said drive rod, the other end of which is pivotally connected to the slider, wherein the slider in the holding position presses the connecting rod against either its top dead center or bottom dead center, and the slider in the retracted position then permits the connecting rod to pivot relative to the drive rod; —a compression spring for biasing the slider toward its holding position.

As a preferred aspect, there is further included a buffer attached to the lower portion of the second repulsion disk, it is configured to avoid hard impacts between the second repulsion disk and the third repulsion disk during downward travel.

As another aspect of the present disclosure, it also relates to a method of controlling a fast mechanical switch, characterized in that it comprises the steps of: when performing an opening operation, a. activating a first electrical terminal to supply power to a first repulsion disk and a second repulsion disk and disabling a third repulsion disk, wherein the direction of current flow in the first repulsion disk and the second repulsion disk is reversed; b. after the first time period of discharge, the first repulsion disk pushes the second repulsion disk based on the electromagnetic repulsion force to drive the transmission rod to accelerate downward; c. after the first electrical terminal discharges for a second time period, the second electrical terminal is enabled to supply power to the third repulsion disk, wherein the direction of current flow in the third repulsion disk and the first repulsion disk is reversed, and the second repulsion disk decelerates downward under the collective force from the first repulsion disk and the third repulsion disk until it passes through a predetermined position at a maximum speed; d. after the first electrical terminal and the second electrical terminal discharge for a third time period, so as to stop the downward movement of the second repulsion disk over the third repulsion disk.

As a preferred aspect, it further includes causing the second repulsion disk to move downward further by a holding mechanism until the connecting rod pivotally connected to the drive rod is held at its bottom dead center position.

As a preferred aspect, when performing the closing operation, a. the first electrical terminal and the second electrical terminal are enabled to supply power to the second repulsion disk and the third repulsion disk, respectively, and the first repulsion disk is disabled, wherein the direction of current flow in the second repulsion disk and the third repulsion disk is reversed; b. after the first time period of discharge, the third repulsion disk pushes the second repulsion disk based on the electromagnetic repulsion force to drive the transmission rod to accelerate upward; c. after the first electrical terminal and the second electrical terminal discharge for a second time period, the second electrical terminal, the first electrical terminal is enabled to supply power to the first repulsion disk, wherein the current flow direction in the first repulsion disk and the second repulsion disk is reversed, and the second repulsion disk decelerates upwardly under the collective force from the first repulsion disk and the third repulsion disk until it passes through the predetermined position at a maximum speed; d. after the first electrical terminal and the second electrical terminal discharge for a third time period, so as to stop the upward movement of the second repulsion disk below the first repulsion disk.

As a preferred aspect, it further includes causing the second repulsion disk to move upward further by a holding mechanism until the connecting rod pivotally connected to the drive rod is held in its top dead center position.

A portion of other features and advantages of the present disclosure will be apparent to those skilled in the art upon reading this application, and another portion will be described in the specific embodiments below in conjunction with the accompanying drawings.

### BRIEF DESCRIPTION OF THE DRAWING

Hereinafter, embodiments of the present disclosure are described in detail in connection with the accompanying drawings, wherein:

FIG. 1: a three-dimensional view of a fast mechanical switch according to the present disclosure;

FIG. 2: a further three-dimensional view of a fast mechanical switch according to the present disclosure, wherein the external housing of the fast mechanical switch is removed to better illustrate its internal construction;

FIG. 3: an exploded view of a fast mechanical switch according to the present disclosure, wherein the internal construction thereof is better shown;

FIG. 4: a cross-sectional view of a fast mechanical switch according to the present disclosure, wherein the fast mechanical switch is in a closing state;

FIG. 5: a cross-sectional view of a fast mechanical switch according to the present disclosure, wherein the fast mechanical switch is in an opening state;

FIG. 6: a circuit diagram of a power supply device according to the present disclosure;

FIG. 7: a schematic diagram of multiple repulsion disks during an opening operation according to the present disclosure;

FIG. 8: a timing diagram of a control method of a fast mechanical switch according to the present disclosure.

### REFERENCE NUMBERS

100—fast mechanical switch; 11—first busbar; 12—second busbar; 121—moving terminal bar; 122—fixed terminal bar; 13—external housing; 131—top cover; 132—bottom cover; 14—vacuum interrupter; 14A—fixed contact; 14B—moving contact; 141—bellows; 142—transmission rod; 15—electric conductor; 16—drive rod; 20—electromagnetic repulsion mechanism; 20A—first repulsion unit; 20B—second repulsion unit; 21—first repulsion disk; 21A—first input terminal; 21B—first output terminal; 22—second repulsion disk; 22A—second input terminal; 22B—second output terminal; 23—third repulsion disk; 23A—third input terminal; 23B—third output terminal; 24—travel limiter; 25—buffer; 26A—first electrical terminal; 26B—second electrical terminal; 30—holding mechanism; 31—connecting rod; 32—slider; 33—holding spring;

### DETAIL DESCRIPTION

A schematic embodiment of the fast mechanical switch and its operating method disclosed herein is now described in detail with reference to the accompanying drawings. Although the accompanying drawings are provided to present some embodiments of the present disclosure, the accompanying drawings do not have to be drawn to the dimensions of the specific embodiments, and certain features may be enlarged, removed or locally dissected to better illustrate and explain the disclosure of the present disclosure. Some of the components in the accompanying drawings may be repositioned according to actual needs without affecting the technical effect. The phrase “in the accompanying drawings” or similar terms appearing in the specification need not refer to all of the accompanying drawings or examples.

Certain directional terms used hereinafter to describe the accompanying drawings, such as “inside,” “outside,” “above,” “below,” and other directional terms will be understood to have their normal meanings and to refer to those directions involved in normal viewing of the accompanying drawings. Unless otherwise indicated, the directional terms described herein are substantially in accordance with conventional directions as understood by those skilled in the art.

The terms “first,” “first one,” “second,” “second one” and similar terms used in the present disclosure do not indicate any order, quantity or importance in the present disclosure, but are used to distinguish one component from other components.

In order to make the purpose, structure, characteristics, and functions of the present disclosure clearer to understand, the following is a detailed description with reference to the embodiments.

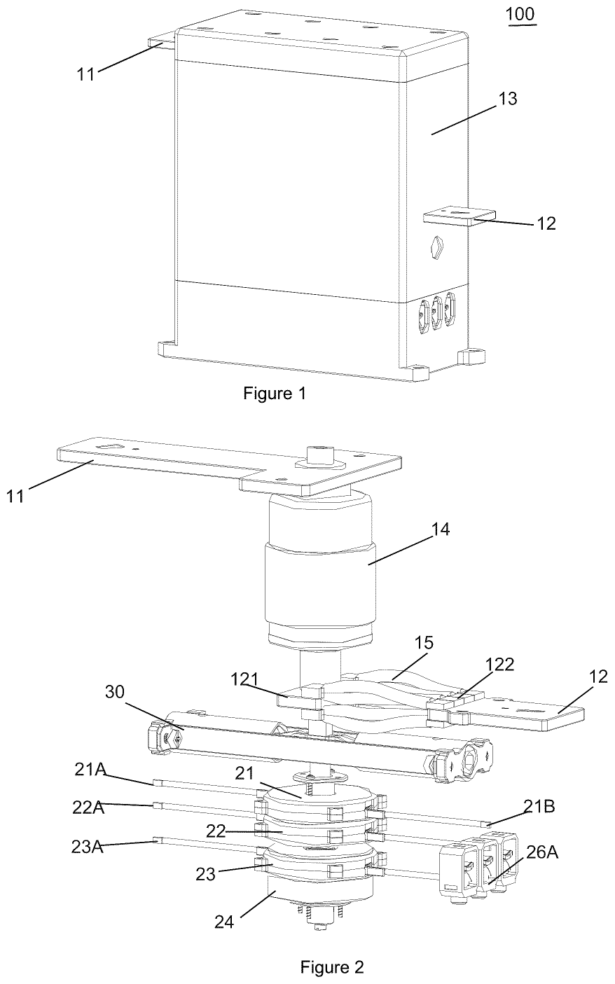

As shown in FIGS. 1-5 of the present disclosure, the fast mechanical switch 100 according to the present disclosure can be used in, for example, a power distribution network in an industrial park, where there is a fault in the power distribution network and there is a need to cut off the impact of the faulty portion of the power distribution network on the operation of other electrical equipment in the park as soon as possible, at which time, the ultra-rapid breaking capacity of the fast mechanical switch 100 in the present disclosure is utilized to achieve the purpose of quickly isolating the fault.

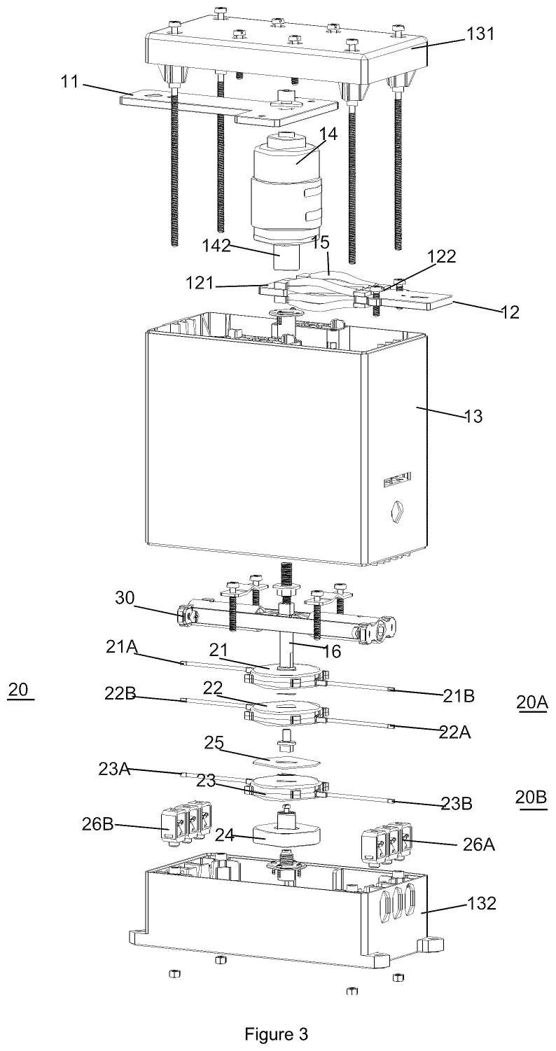

FIGS. 1-3 show three-dimensional views of a fast mechanical switch 100 according to the present disclosure in various states, wherein the fast mechanical switch 100 comprises a closed housing 13, which is herein clearly shown in FIG. 3. The housing consists of a top cover 131 constituting the upper portion of the housing, a main body forming an internal chamber, and a bottom cover 132 constituting the lower portion of the housing, wherein the top cover 131 and the bottom cover 132 can be fixedly connected to the main body of the housing by means of a plurality of fasteners so as to define therein a cavity capable of accommodating the following electrical device. As shown in FIG. 3, the cavity is provided from top to bottom with a vacuum interrupter, wherein the vacuum interrupter 14 is provided with a fixed contact 14A that is stationary and a moving contact 14B that can be slidably coupled thereto, wherein the fixed contact 14A is coupled to a first busbar 11 projecting out of the housing 13, and the moving contact 14B is coupled to a second busbar 12 projecting out of the housing 13. In the case of this embodiment, the first busbar 11 can be, for example, a high-voltage bus, and the second busbar 12 can be an earth bus, thereby allowing the fast mechanical switch 100 to be connected to a distribution network, such as an industrial park, with the aid of the first busbar 11 and the second busbar 12.

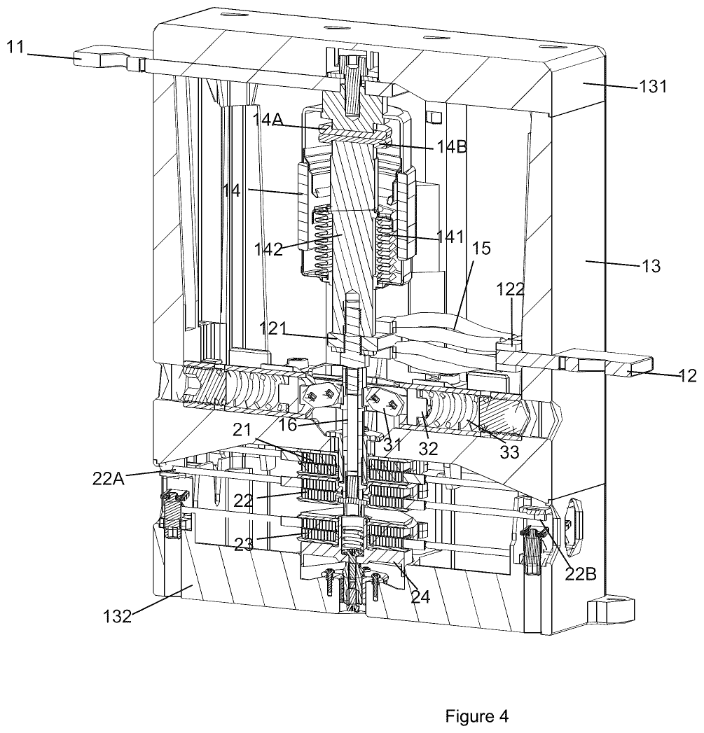

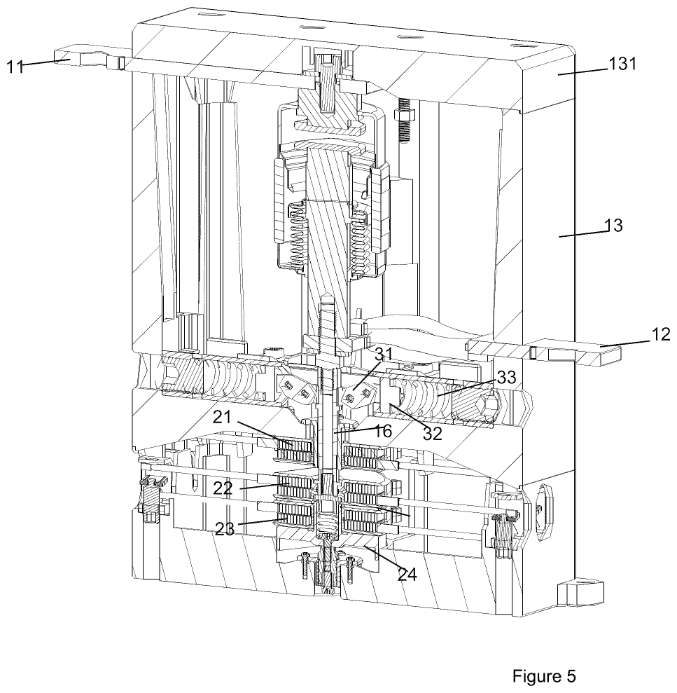

Preferably, as shown in FIGS. 4-5, a bellows 141 is provided along the inner wall of the vacuum interrupter 14 and disposed on the outer side of the transmission rod 142, wherein an upper end of the bellows 141 is fixedly connected to the transmission rod 142 with the aid of a fastener, such as a clamp, and another end of the bellows 141 is hermetically connected to the end of the vacuum interrupter with the thrust of a fastener, such as a snap ring. In the present disclosure, with the aid of this design, although the transmission rod 142 needs to move freely up and down in the vertical direction relative to the vacuum interrupter 14, the presence of the hermetic bellows 141 between them ensures that the interior of the vacuum interrupter 14 remains hermetically isolated from the exterior of the vacuum interrupter 14 during the operations of the transmission rod 142 when driving the moving contact 14B to open and close. Therefore the arc formed between the moving contact 14B and the fixed contact 14A does not propagate to the outside of the vacuum interrupter 14, thereby greatly improving the range of application of the fast mechanical switch and the service life of the components, and ensuring the safety of the electrical equipment during use.

It is also conceivable that a magnetic field generating device is preferably provided outside of the vacuum interrupter 14, so that a longitudinal magnetic field along the axial direction of the vacuum interrupter 14 and parallel to the axes of the moving contact 14B and the fixed contact 14A is generated in the vacuum interrupter. As a result, the energy of the anode spots on the moving contact 14B and the fixed contact 14A can be reduced, and thus the breaking capacity of the fast mechanical switch can be improved.

In order to realize rapid opening and closing of the vacuum interrupter 14, an electromagnetic repulsion mechanism 20 is provided in the housing 13 and located below the vacuum interrupter 14, which is fixedly connected to a transmission rod 142 projecting through the vacuum interrupter 14, wherein the electromagnetic repulsion mechanism 20 has: —a first repulsion unit 20A electrically connected to a first electrical terminal 26A, wherein the first repulsion unit 20A comprises a first repulsion disk 21 which is stationary and a second repulsion disk 22 which is located underneath and separated from it, wherein the second repulsion disk 22 is fixedly connected to the transmission rod 142 via a driving rod 16 which is inserted through the first repulsion disk 21 to drive the vacuum interrupter 14 to open or close, wherein a reset spring is provided underneath the driving rod 16 to bias it upwardly to allow the fixed contact 14A and the moving contact 14B engage against with each other when in the initial position. The electromagnetic repulsion mechanism 20 further comprises a second repulsion unit 20B electrically connected to a second electrical terminal 26B, which is independent of the first electrical terminal 26A, and the repulsion unit comprises a third repulsion disk 23 located below and spaced apart from the second repulsion disk 22. As will be described in more detail below, in the present disclosure, since the first electrical terminal 26A and the second electrical terminal 26B are separate electrical circuits independent from each other, it is possible to correlate the first electrical terminal 26A and the second electrical terminal 26B in a relationship or term of such as timing with the aid of an electrical design or logic programming to allow the second electrical terminal 26B to be constructed to control the third repulsion disk 23 in response to operation of the first repulsion unit 20A so that the third repulsion disk 23 provides resistance to the second repulsion disk 22 when it moves downwardly for opening and provides a thrust to the second repulsion disk 22 when it moves upwardly for closing. Herein, the term “resistance” means that the direction of the force exerted by the third repulsion disk 23 on the second repulsion disk 22 is opposite to the direction of its movement, and the term “thrust” means that the direction of the force exerted by the third repulsion disk 23 on the second repulsion disk 22 is the same as the direction of its movement.

The first repulsion disk 21, the second repulsion disk 22 and the third repulsion disk 23 of the present disclosure are better illustrated in FIGS. 4-5, wherein each of these repulsion disks comprises a disk-shaped frame base and a first repulsion coil and a second repulsion coil secured to the two axial sides of the frame base, wherein the first repulsion coil is provided with input terminals 21A-23A and the second repulsion coil is provided with output terminals 21B-23B. Specifically, taking the first repulsion disk 21 as an example, the first repulsion disk 21 is provided with a center hole for free movement of the drive rod 16 passing in an upward and downward direction, and it includes a disk-shaped frame base and a first repulsion coil and a second repulsion coil fixed on the upper and lower sides of the frame base. Herein, the frame base may be, for example, a disk-like structure forged using 45# steel, and the first repulsion coil and the second repulsion coil may be of the same structure, with the axes of the two coils and the axes of the center hole being substantially coincident. The frame base is provided with an annular portion for forming a mounting annular groove for mounting the first repulsion coil and the second repulsion coil, the two annular portions being spaced apart along the axial direction of the first repulsion disk 21 and opposite to each other. As a result, the mounting annular groove includes an inner groove wall proximate to the center bore, an upper groove wall and a lower groove wall defined by the upper and lower annular portions, respectively, and an outer peripheral wall formed by the external housing of the repulsion disk. The frame base is provided with a first input terminal 21A and a first output terminal 21B for leading a wire end of the repulsion coil, which are located at each end of the diameter of the frame base. Herein, the first repulsion coil and the second repulsion coil are both made of copper strap wire densely wound into a disk, and spaced apart into the mounting annular groove for pre-fixing, respectively, and then the first repulsion coil and the second repulsion coil are encapsulated with the frame base using a casting tooling. When in use, by controlling the direction of the currents in the first and second repulsion coils, a repulsive force is generated by the repulsion coils of the other repulsion disks paired with each of them, so as to realize the application of a resistance or a thrust to the second repulsion disk 22 to make a reciprocating movement in the axial direction. Herein, the second repulsion disk 22 and the third repulsion disk 23 may adopt the same structure as the first repulsion disk 21, which will not be repeated herein. It is to be noted that the second repulsion disk 22 has a drive rod 16 in its upper part which is threaded through the first repulsion disk 21 and fixedly connected to the transmission rod 142 to drive the vacuum interrupter 14 to open or close, and has a buffer 25 attached to its lower part to avoid the hard impact during downward between the second repulsion disk 22 and the third repulsion disk 23, and to prevent collision between the second repulsion disk 22 and the third repulsion disk 23 if both of them are too close or the holding mechanism disabled, thus causing the electromagnetic repulsion mechanism 20 to malfunction or affecting its service life.

Preferably, the repulsion coils in the first repulsion disk 21 and the second repulsion disk 22 of the first repulsion unit are selected to be coils with higher driving efficiency. The form scale factors of two coils can be defined here to characterize the driving efficiency of the repulsion coil, α is the ratio of the coil height to the average coil diameter; β is the ratio of the coil radial thickness to the average coil diameter. The person skilled in the art can verify, for example with the aid of simulation and experimentation, that the smaller the form scale factor α and the larger the β of the coil, the higher the driving efficiency of the repulsion mechanism. Therefore, the repulsion coil of the first repulsion unit is selected to have a coil specification in which the form scale parameter α is as small as possible and β is as large as possible while satisfying the technical conditions. In order to maximize the driving efficiency, the external dimensions of the repulsion coil in the first repulsion disk 21 and the repulsion coil in the second repulsion disk 22 are maintained to be the same.

In order to allow the first repulsion disk 21 to provide a resistance or a thrust to the second repulsion disk 22 for reciprocating movement in the axial direction, herein, for example, the output terminal 21B of the first repulsion disk 21 and the input terminal 22A of the second repulsion disk 22 can be connected in series to the first electrical terminal 26A to form a series circuit between them. Since the current flow will be backwardly directed from the output terminal 21B of the first repulsion disk 21 and redirected into the second repulsion disk 22, this thereby causes the direction of the current flow of the repulsion coil in the first repulsion disk 21 and the direction of the current flow of the repulsion coil in the second repulsion disk 22 to be reversed and always generates repulsive force between the first repulsion disk 21 and the second repulsion disk 22. Since the first repulsion disk 21 is always located above the second repulsion disk 22, the repulsion force is used in the downward movement of the second repulsion disk 22 as a thrust when opening and in the upward movement of the second repulsion disk 22 as a resistance when closing. In this circuit connection, each of the terminal post in the first electrical terminal 26A can be located on one side of the housing 13, such as on the side near the first input terminal 21A and the second output terminal 22B in FIG. 3 to form a closed current loop. Of course, it can also be conceivable that the output terminal 21B of the first repulsion disk 21 and the input terminal 22A of the second repulsion disk are each connected in parallel to the first electrical terminal 26A so as to form a parallel circuit, which the current flows in the opposite direction therebetween, thereby generating repulsive force between the first repulsion disk 21 and the second repulsion disk 22. In this case, the terminal post of the first electrical terminal 26A are located on the two sides of the housing respectively, so that when the first repulsion disk 21 and the second repulsion disk 22 are connected in parallel, they are reversed with respect to each other in the term of the direction of current flow of the first electrical terminal 26A.

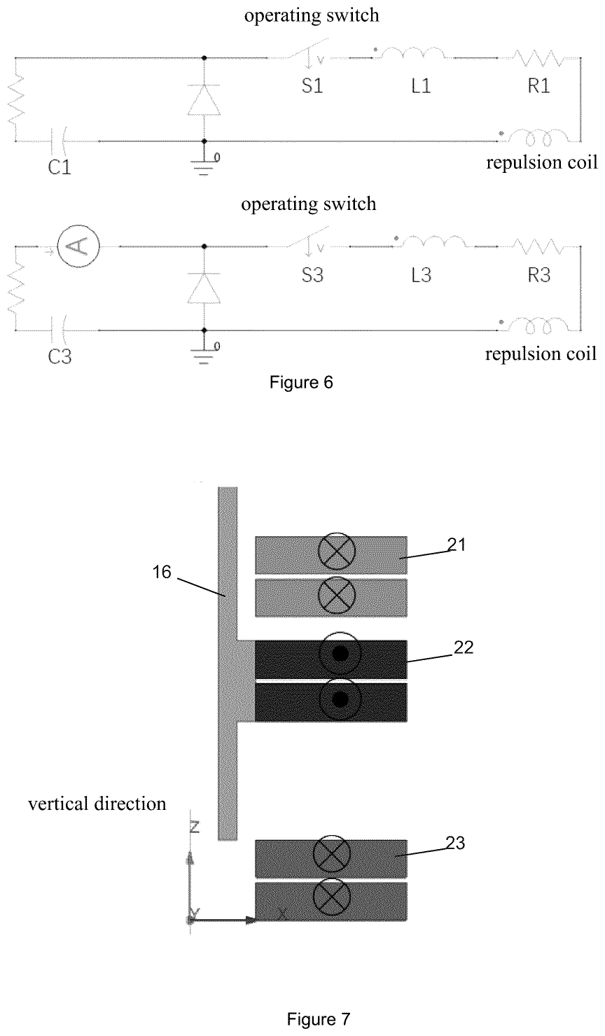

As shown in FIG. 3, a second electrical terminal 26B is provided adjacent to but spaced apart from the first electrical terminal 26A so that they are electrically independent. The second electrical terminal 26B powers a third repulsion disk 23 located below and spaced apart from the second repulsion disk 22, to allow the third repulsion disk 23 to also apply a force to the second repulsion disk 22 and form a second repulsion unit 20B therebetween when the second electrical terminal 26B is activated. Herein, for example, as shown in FIG. 6, both the first electrical terminal 26A and the second electrical terminal 26B are configured to connect with an energy storage capacitor C, a current limiting resistor R, and an operation switch S capable of controlling the current conduction of the repulsion disk in series. As a result, a function of selectively and chronologically supplying directional currents to the first repulsion unit 20A and the second repulsion unit 20B via the first electrical terminal 26A and the second electrical terminal 26B, respectively, can be realized. Herein, the energy storage capacitor C1 and the operation switch S1 are designed to supply a directional current to at least one repulsion coil of the first repulsion unit 20A, and the energy storage capacitor C3 and the operation switch S3 are designed to supply a directional current to the at least one repulsion coil of the second repulsion unit 20B.

In order to meet the different requirements for the opening and closing operations, a travel limiter 24 is preferably provided below the third repulsion disk 23, wherein the travel limiter 24 is, for example, a disk that can be screwed into the bottom cover 132 at different depths, whereby the third repulsion disk 23 can be screwed at different heights with respect to the bottom cover 132, respectively, so as to adjust the distance between the third repulsion disk 23 and the first repulsion disk 21 (corresponding to the maximum vertical travel of the second repulsion disk 22).

Preferably, a holding mechanism 30 pivotally connected to the drive rod 16 between the vacuum interrupter 14 and the electromagnetic repulsion mechanism 20 is also included in the housing 13, wherein the holding mechanism 30 is fixedly connected to the body of the housing 13 and comprises: a slider 32 capable of sliding between a holding position and a retracted position, a connecting rod 31 pivotally connected to the drive rod 16, the other end of which is pivotally connected to the slider 32, wherein the slider in the holding position presses the connecting rod against its top dead center (see FIG. 4) or bottom dead center (see FIG. 5), and the slider in the retracted position allows the connecting rod to pivot with respect to the drive rod, and a compression spring 33 that biases the slider 32 toward its holding position. Thus, in the fast mechanical switch of the present disclosure, the holding mechanism 30 is used to hold the moving contact 14B to stabilize the connecting rod 31 and its connected drive rod 16 in the top dead center or bottom dead center during closing and opening, respectively, and the repulsion mechanism 20 acts as a driving part that can overcome the force of the holding mechanism 30 to push the upward and downward movement of the drive rod 16. The multiple repulsion coils in the first repulsion unit generate repulsive force after the current in the opposite direction is energized to make the driving rod 16 move downward, which pushes the switch to open to make the high-voltage bus and the ground bus to achieve the effect of shutting off.

In order to further illustrate the operating principle and control method of the fast mechanical switch provided in the embodiment of the present disclosure to realize the opening or closing operation, the working process and the control method are described in detail in conjunction with the accompanying FIGS. 6-8, as follows:

Circuit diagrams and operation timing diagrams for performing an opening operation are described in FIGS. 6-8, which comprise:

FIG. 6 shows a circuit diagram of the first electrical terminal 26A (upper) and a circuit diagram of the second electrical terminal 26B (lower), wherein the first electrical terminal 26A is connected in series to the energy storage capacitor C1 capable of supplying power to the first repulsion disk 21 and the second repulsion disk 22, to a current limiting resistor R1, and to an operation switch S1 controlling the conduction of the current to the first repulsion disk 21 and the second repulsion disk 22, while the second electrical terminal 26B is connected in series to an energy storage capacitor C3 capable of supplying power to the third repulsion disk 23, to a current limiting resistor R3, and to an operation switch S3 controlling the conduction of the current to the third repulsion disk 23. When opening operation is required,

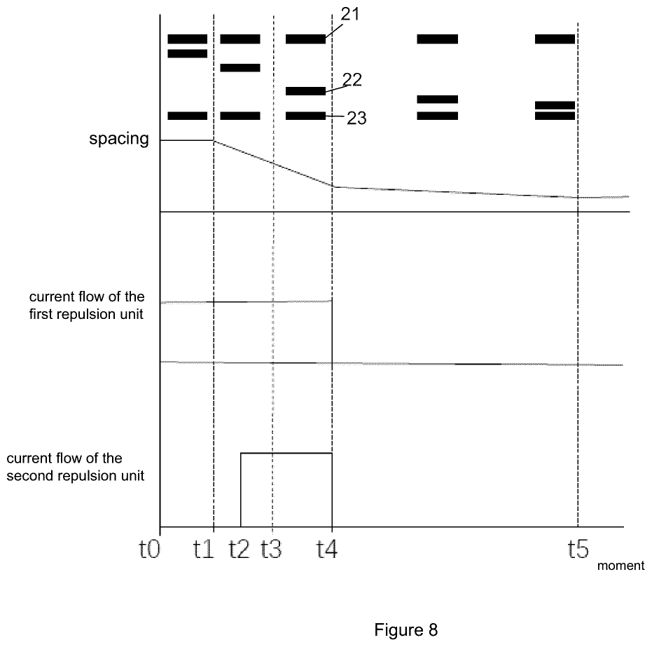

First, proceed with the step a. At this time, from moment t0 in FIG. 8, the first electrical terminal 26A is activated to supply power to the first repulsion disk 21 and the second repulsion disk 22 (for example, close the operating switch S1) and the third repulsion disk 23 is deactivated (for example, open the operating switch S3), wherein the direction of current flow in the first repulsion disk 21 and the second repulsion disk 22 is reversed (as shown in FIG. 7, wherein the current flows through each of the two repulsion coils in the first repulsion disk 21 in a direction inwardly along the paper surface, and at this time flows through the two repulsion coils in the second repulsion disk 22 in the opposite direction outwardly along the paper surface), which can be achieved, for example, with the aid of connecting the first repulsion disk 21 and the second repulsion disk 22 in series or connecting the first repulsion disk 21 and the second repulsion disk 22 in parallel, wherein the second repulsion coil 22 remains stationary at this point in time due to the holding mechanism 30 having a considerable holding force despite the fact that at this point in time the first repulsion disk 21 and the second repulsion disk 22 have a certain amount of repulsive force, wherein the step a is clearly shown at the moments t0 to t1 in FIG. 8, wherein the distance between the second repulsion disk 22 and the third repulsion disk 23 (corresponding to the distance between the moving contact 14B and the fixed contact 14A) is maximized, at which time, a current has been energized in the first repulsion unit 20A, but no current has been energized in the second repulsion unit 20B;
b. After the first time period of discharging to the moment t1, at which time the electromagnetic repulsive force exerted by the first repulsion disk 21 to the second repulsion disk 22 has been sufficient to overcome the holding force of the holding mechanism 30 thereby pushing the second repulsion disk 22 to drive the transmission rod 142 to accelerate move downwardly based on the electromagnetic repulsive force, wherein step b is clearly illustrated in FIG. 8 from the moment t1 to the moment t2, wherein the distance between the second repulsion disk 22 and the third repulsion disk 23 begins to decrease, at which time a current has been energized in the first repulsion unit 20A, but the current is still not energized in the second repulsion unit 20B;
c. After the first electrical terminal is discharged for the second time period to the moment t2, the second electrical terminal 26B is activated at this time to supply power to the third repulsion disk 23, wherein the direction of current flow in the third repulsion disk 23 and the second repulsion disk 22 is reversed (as illustrated in FIG. 7, wherein the current flows in a direction outwardly along the paper surface through each of the two repulsion coils within the second repulsion disk 22, and at this time flows in the opposite, inward direction along the paper surface through the two repulsion coils in the third repulsion disk 23), the second repulsion disk 22 decelerates downwardly under the collective force of the first repulsion disk 21 and the third repulsion disk 23 until it passes through the predetermined position with a maximum speed at the moment of t3, and then the electromagnetic force causes the second repulsion disk 22 to begin to decelerate and continue to move downwardly due to the continued discharging of the second electrical terminal 26B, wherein the step c is clearly shown in FIG. 8 between the moment t2 and t3, wherein the distance between the second repulsion disk 22 and the third repulsion disk 23 continues to decrease, at which time a current has been energized in the first repulsion unit 20A, but a current has also been energized in the second repulsion unit 20B;
d. After discharging the first electrical terminal and the second electrical terminal for the third time period to the moment t4, and then operating the switches S1 and S3 to open to stop the downward movement of the second repulsion disk 22 above the third repulsion disk 23, wherein step d is clearly illustrated in FIG. 8 from the moments t3 to t4, wherein the distance between the second repulsion disk 22 and the third repulsion disk 23 continues to decrease, at which time the first repulsion unit 20A and the second repulsion unit 20B are both energized with current;
e. Since the second repulsion disk 22 is not yet fully at the bottom dead center of the drive rod 16, in order to avoid its upward and downward movement, the second repulsion disk 22 is caused to further downwardly travel by the compression spring 33 in the holding mechanism 30 until the connecting rod 31 pivotally coupled to the drive lever 16 is retained in its bottom dead center position at the moment t5, thereby completing the entire opening operation, at which time the moving contact 14B is stably maintained in its opening position, wherein step e is clearly shown at moment t4 to t5 in FIG. 8, wherein the distance between the second repulsion disk 22 and the third repulsion disk 23 is slowly reduced to a minimum space. At this time, neither the first repulsion unit 20A nor the second repulsion unit 20B is supplied with a current in it.

For the closing operation, the timing sequence of the operation is substantially the same as that illustrated in FIG. 8, as follows:
A1. The first electrical terminal 26A and the second electrical terminal 26B are activated to supply power to the second repulsion disk 22 and the third repulsion disk 23, respectively, and the first repulsion disk 21 is deactivated, wherein the direction of current flow in the second repulsion disk 22 and the direction of current flow in the third repulsion disk 23 is reversed;
B1. After a first time period of discharging, the third repulsion disk 23 pushes the second repulsion disk 22 to drive the transmission rod 142 to accelerate upwardly based on the electromagnetic repulsion force;
C1. After the first electrical terminal 26A and the second electrical terminal 26B are discharged for a second time period, the first electrical terminal 26A is activated to supply power to the first repulsion disk 21, wherein the direction of current flow in the first repulsion disk 21 and the second repulsion disk 22 is reversed, and the second repulsion disk 22 decelerates upwardly until it passes through the predetermined position at a maximum speed under the collective force of the first repulsion disk 21 and the third repulsion disk 23;
D1. Discharge the first electrical terminal and the second electrical terminal for the third time period until stop the upward motion of the second repulsion disk below the first repulsion disk.

Finally, the second repulsion disk is caused by the holding mechanism to travel further upward until the connecting rod pivotally connected to the drive rod is held in its top dead center position.

Alternatively, it is also possible to always deactivate the first repulsion disk 21, thereby ensuring that the second repulsion disk 22 is only subjected to the electromagnetic force of the third repulsion disk 23 during the closing operation. This is beneficial because it can be ensured that the second repulsion disk 22 can be moved upwardly into place in the shortest time, thereby increasing the responsiveness of the fast mechanical switch.

As can be seen from the above, by adopting the coil-coil structure as the driving structure of the repulsion mechanism in the present disclosure, compared with the coil-metal disk structure, it has higher drive efficiency and higher control accuracy and lower control complexity; and it also reduces the size of the driving components and the motion inertia of the fast-acting repulsion unit in order to protect the components of the repulsion mechanism, and prolongs the life of the repulsion mechanism. The use of independently energized repulsion disks at the first and second electrical terminals to form a bidirectional repulsion structure helps to improve the rapidity of switch closing and opening; at the same time, the use of transverse insulating grids and the addition of magnetic field distribution in the vacuum interrupter enhances the arc extinguishing effect by lengthening the arc and increasing the cooling effect.

It should be understood that, although this specification is described in accordance with the various embodiments, not each embodiment contains only an independent technical program, the specification of this narrative is only for the sake of clarity, the person skilled in the art should take the specification as a whole, the technical program in the various embodiments can be combined appropriately, to form other embodiments that can be understood by the person skilled in the art.

The above description is only an illustrative specific embodiment of the present disclosure, and is not intended to limit the scope of the present disclosure. Any equivalent changes, modifications and combinations made by any person skilled in the art without departing from the concepts and principles of the present disclosure shall fall within the scope of protection of the present disclosure.

1. A fast mechanical switch, comprising:
a closed housing;
a vacuum interrupter, wherein the vacuum interrupter is provided with a stationary fixed contact and a moving contact being capable of slidingly engage therewith, wherein the fixed contact is connected to a first busbar projecting out of the housing and the moving contact is connected to a second busbar projecting out of the housing;
an electromagnetic repulsion mechanism located below the vacuum interrupter, which is fixedly connected to the vacuum interrupter via a transmission rod, wherein the electromagnetic repulsion mechanism comprises:
a first repulsion unit electrically connected to the first electrical terminal, comprising a first repulsion disk which is fixed and a second repulsion disk which is located below thereof and separated therefrom, wherein the second repulsion disk is fixedly connected to the transmission rod via a drive rod passing through the first repulsion disk to drive the vacuum interrupter to open or close;
a second repulsion unit electrically connected to a second electrical terminal independent of the first electrical terminal, comprising a third repulsion disk disposed below and spaced apart from the second repulsion disk, wherein the second electrical terminal is configured to operatively control the current supplied to the third repulsion disk in response to the first repulsion unit such that the third repulsion disk applies a resistance to the second repulsion disk when the second repulsion disk is moved downwardly for opening and applies a thrust to the second repulsion disk when it is moved upwardly for closing.

2. A fast mechanical switch according to claim 1, characterized in that each of the first repulsion disk, second repulsion disk, and third repulsion disk comprises a disk-shaped frame base, and a first repulsion coil and second repulsion coil fixed to both axial sides of the frame base, wherein the first repulsion coil is provided with an input terminal and the second repulsion coil is provided with an output terminal.

3. A fast mechanical switch according to claim 2, characterized in that the output terminal of the first repulsion disk and the input terminal of the second repulsion disk are both serially connected to the first electrical terminal to form a series circuit therebetween so that the current flow in the repulsion coil of the first repulsion disk and the current flow in the repulsion coil of the second repulsion disk are reversed and a repulsion force is generated between the first repulsion disk and the second repulsion disk.

4. A fast mechanical switch according to claim 2, characterized in that the output terminal of the first repulsion disk and the input terminal of the second repulsion disk are connected in parallel to the first electrical termination to form a parallel circuit with opposite current flow direction therebetween, thereby generating repulsive forces between the first and second repulsion disks.

5. A fast mechanical switch according to claim 2, characterized in that both of the first electrical terminal and the second electrical terminal are configured to serially connect to an energy storage capacitor, a current limiting resistor, and an operating switch capable of controlling the current conduction of the repulsion disk.

6. A fast mechanical switch according to claim 1, characterized in that the inner wall of the vacuum interrupter is provided with a bellows disposed on the outer side of the transmission rod, wherein one end of the bellows is hermetically connected to an end of the vacuum interrupter to keep the hermeticity of the vacuum interrupter.

7. A fast mechanical switch according to claim 1, characterized in that further comprises a holding mechanism pivotally connected to the drive rod between the vacuum interrupter and the electromagnetic repulsion mechanism, comprising:
a slider capable of sliding between a holding position and a retracted position;
a connecting rod pivotally connected to the drive rod, the other end of which is pivotally connected to the slider, wherein the slider in the holding position presses the connecting rod against its top dead center or bottom dead center, and wherein the slider in the retracted position permits the connecting rod to pivot relative to the drive rod;
a compression spring for biasing the slider toward its holding position.

8. A fast mechanical switch according to claim 1, characterized in that further comprises a buffer attached to the lower portion of the second repulsion disk, which is configured to avoid hard impacts between the second repulsion disk and the third repulsion disk during downward travel.

9. An operating method of a fast mechanical switch according to claim 1, characterized in that it comprises the following steps in performing an opening operation:
activating the first electrical terminal to supply power to the first repulsion disk and the second repulsion disk and deactivating the third repulsion disk, wherein the direction of current flow in the first repulsion disk and the second repulsion disk is opposite;
after the first time period of power supply, the first repulsion disk pushes the second repulsion disk to accelerate the transmission rod downwardly based on electromagnetic repulsive force;
after a second time period of power supply via the first electrical terminal, activating the second electrical terminal to supply power to the third repulsion disk, the current flow direction in which is opposite to the current flow direction in the second repulsion disk, and the second repulsion disk decelerates downwardly under the collective force of the first repulsion disk and the third repulsion disk until it passes through the predetermined position at a maximum speed;
maintaining the power supply via the first electrical terminal and the second electrical terminal for a third time period to stop the downward movement of the second repulsion disk above the third repulsion disk.

10. An operating method according to claim 9, characterized in that further comprises causing the second repulsion disk to further move downward by a holding mechanism until the connecting rod pivotally connected to the drive rod is held in its bottom dead center.

11. An operating method according to claim 9, characterized in that, when performing the closing operation:
the first electrical terminal and the second electrical terminal are activated to supply power to the second repulsion disk and the third repulsion disk, respectively, and deactivate the first repulsion disk, wherein the direction of current flow in the second repulsion disk and the third repulsion disk is opposite;
after the first time period of power supply, the third repulsion disk pushes the second repulsion disk to accelerate the transmission rod upwardly based on electromagnetic repulsive force;
after a second time period of power supply via the first electrical terminal and the second electrical terminal, the first electrical terminal is activated to supply power to the first repulsion disk, wherein the direction of current flow in the first repulsion disk and the second repulsion disk is opposite, and the second repulsion disk is decelerated upwardly by the collective force of the first repulsion disk and the third repulsion disk until it passes through the predetermined position at a maximum speed;
after the power supply via the first electrical termination and the second electrical termination for a third time period to stop the upward movement of the second repulsion disk below the first repulsion disk.

12. An operating method according to claim 11, characterized in that further comprises causing the second repulsion disk to further move upward by a holding mechanism until the connecting rod pivotally connected to the drive rod is held in its top dead center.
